(19) United States
(12) Patent Application Publication
(10) Pub. No.: US 2011/0122230 A1
(43) Pub. Date: May 26, 2011

(54) CODING DEVICE FOR 3D VIDEO SIGNALS

(75) Inventors: Guillaume Boisson, Pleumeleuc (FR); Paul Kerbiriou, Thorigne-Fouillard (FR); Patrick Lopez, Livre Sur Changeon (FR)

(73) Assignee: THOMSON LICENSING, Boulogne-Billancourt (FR)

(21) Appl. No.: 12/737,442

(22) PCT Filed: Jul. 21, 2009
(86) PCT No.: PCT/EP2009/059331

§ 371 Date: Jan. 14, 2011

(30) Foreign Application Priority Data
Jul. 21, 2008 (FR) 0854934

(51) Int. Cl. H04N 13/02

(52) U.S. Cl. 348/47; 348/46

(57) ABSTRACT

The device comprises the means to generate a stream structured on several levels:
a level 0 comprising two layers, a base layer containing the video data of the right image and a level 0 enhancement layer containing the video data of the left image, or conversely,
a level 1 comprising two enhancement layers, a first level 1 enhancement layer containing a depth map relating to the image of the base layer, a second level 1 enhancement layer containing a depth map relating to the level 0 enhancement layer image,
a level 2 comprising a level 2 enhancement layer containing occlusion data relating to the base layer image.

Applications for coding 3D data relating to 3D digital cinema, 3D DVD, 3D TV, etc.

### SCOPE OF THE INVENTION

The invention relates to the coding of 3D video signals, specifically the transport format used to broadcast 3D contents.

The domain is that of 3D video, that includes cinema content used for cinema projection, for diffusion on DVD media or for broadcast by television channels. Thus it specifically involves 3D digital cinema, 3D DVD and 3D television.

### PRIOR ART

Numerous systems exist today for the display of images in relief.

3D digital cinema, known as the stereoscopic system, is based on the wearing of glasses for example with Polaroid filters and uses a stereographical pair of views (left/right), or the equivalent of two “reels” for a film.

The 3D screen for digital television in relief, known as the autostereoscopic system as it does not require the wearing of glasses, is based on the use of Polaroid lenses or bands. These systems are designed to enable the viewer to have, in an angular cone, a different image arriving on the right eye and the left eye:
The 3DTV screen manufactured by the company Newsight comprises a parallax barrier, transparent and opaque film corresponding to vertical slots that behave like the optical centre of a lens, the rays that are not deviated being the rays that traverse these slots. The system in fact uses 8 views, 4 views on the right and 4 views on the left, these views enable the creation of the motion parallax effect, during a change in the point of view, or movement of the viewer. This motion parallax effect provides a better impression of immersion of the viewer in the scene than that generated by a simple autostereoscopic view, that is to say a single view on the right and a single view on the left creating a stereoscopic parallax. The 3DTV screen from Newsight must be fed at input by an 8 view multi-view stream format still undergoing standardization. The extension MVC (Multi View Coding) to the JVT MPEG/ITU-T MPEG4 AVC/H264 standard relating to multi-view video coding, thus proposes a coding of each of the views for their transmission in the stream, there is no image synthesis at the arrival.
The 3DTV screen manufacture by the Philips company comprises lenses in front of the television panel. The system exploits 9 views, 4 views on the right and 4 views on the left and one central 2D view. It uses the format “2D+z”, that is to say a standard 2D video stream transporting a conventional 2D video plus auxiliary data corresponding to a depth map z, standardized by the standard MPEG-C part 3. The 2D image is thus synthesized using the depth map to provide the right and left images to be displayed on the screen. This format is compatible with the current standard relating to 2D images but is insufficient to provide quality 3D images, in particular if the number of views exploited is high. For example, the data available still do not enable to correctly process the occlusions, generating artefacts. One solution called LDV (Layered Depth Video) consists in representing a scene by successive shots. Transmitted then in addition to the “2D+z” is content data relating to these occlusions that are layers of occlusions constituted of a map of colours defining the value of occluded pixels and a depth map for these occluded pixels. To transmit this data, Philips use the following format: the image, for example HD (High Definition), is divided into four sub-images, the first sub-image is the central 2D image, the second is the depth map, the third is the occlusion relative to the pixel values map and the last is the depth relative to the occlusions map.

It should also be mentioned that the current solutions lead to a loss in spatial resolution, on account of the complimentary information to be transmitted for the 3D display. For example, for a high definition panel, 1080 lines of 1920 pixels, each of the views among the 8 or 9 views will have a spatial resolution loss of a factor of 8 or 9, the transmission bitrate used and the number of pixels of the television remaining constant.

Studies in the domain of the display of images in relief on screens are orientated today towards:
autostereoscopic multiview systems, that is to say the use of more than 2 views, without wearing of special glasses. It involves for example the LDV format previously mentioned or the MVD (Multiview Video+Depth) format using depth maps,
stereoscopic systems, that is to say the use of 2 views, and the wearing of special glasses. The content, that is to say the data exploited, can be stereoscopic data relating to two images right and left, or data corresponding to the LDV format or data relating to MVD format. The Samsung 3D DLP (Digital Light Processing) Rear Projection HDTV system, the 3D Plasma HDTV system by the same manufacturer, the Sharp 3D LCD system, etc. can be cited.

Moreover, it is noted that the contents relating to 3D digital cinema can be distributed by the intermediary of DVD media, systems studied currently are called for example Sensio or DDD.

The formats of video elementary streams used to exchange 3D contents are not harmonized. Proprietary solutions coexist. A single format is standardized that is a transport encapsulation format (MPEG-C part 3) but it relates only to the encapsulation system in the MPEG-2 TS transport stream and therefore does not define a new format for the elementary stream.

This multiplicity of video elementary stream formats for 3D video contents, this absence of convergence, does not facilitate conversions from one system to another, for example from digital cinema to DVD distribution and TV broadcast.

One of the purposes of the invention is to overcome the aforementioned disadvantages.

### SUMMARY OF THE INVENTION

The purpose of the invention is a coding device intended to exploit the data from different 3D production means, data relating to a right image and a left image, data relating to depth maps associated with right images and/or left images and/or data relating to occlusion layers, characterized in that it comprises the means to generate a stream structured on more than one level:
a level 0 comprising two independent layers, a base layer containing the video data of the right image and an enhancement layer at level zero containing the video data of the left image, or conversely,
a level 1 comprising two independent enhancement layers, a first enhancement layer 1 containing a depth map relating to the image of the base layer, a second level 1 enhancement layer containing a depth map relating to the level 0 enhancement layer image,
a level 2 comprising a level 2 enhancement layer containing occlusion data relating to the base layer image.

According to a particular embodiment, the data relating to level 0, level 1 or level 2 come from 3D synthesis image generation means and/or the 3D data means of production from:
2D data from 2D cameras and/or 2D video content and/or
data from stereo cameras and/or multiview cameras.

According to a particular embodiment, the 3D data production means use, for the calculation of data relating to level 1, specific means for depth information acquisition and/or means for depth map calculation from data coming from stereo cameras and/or multiview cameras.

According to a particular embodiment, the 3D data production means use, for the calculation of data relating to level 2, occlusion map calculation means from data coming from depth information acquisition means, from stereo cameras and/or multiview cameras.

The purpose of the invention is also a decoding device for 3D data from a stream for their display on a screen, structured in several levels:
a level zero comprising two independent layers, a base layer containing the video data of the right image and an enhancement layer at level zero containing the video data of the left image, or conversely,
a level 1 comprising two independent enhancement layers, a first enhancement layer of level 1 containing a depth map relating to the image of the base layer, a second enhancement layer of level 1 containing a depth map relating to the level 0 enhancement layer image,
a level 2 comprising a level 2 enhancement layer containing occlusion data relating to the base layer image,

for their display on a display device, characterized in that it comprises a 3D display adaptation circuit using the data of one or more data stream layers received to render them compatible with the display device.

According to a particular embodiment, the 3D display adaptation circuit uses:
level 0 layers when the display is on a 3D cinema screen, on a 2 view stereoscopic screen requiring the use of glasses or on a 2 view autostereoscopic screen,
the base layer and the first level 1 enhancement layer when the display is on a Philips “2D+z” type screen,
all of the level 0 and level 1 layers when the display is on an MVD type autostereoscopic 3DTV,
the base layer, the first enhancement layer of level 1 and of level 2 when the display is on a LDV type screen.

The purpose of the invention is also a video data transport stream, characterized in that the stream syntax differentiates the data layers according to the following structure:
a layer of level 0 composed of two independent layers, one base layer containing the video data of the right image and an enhancement layer containing video data of the left image, or conversely,
an enhancement layer of level 1 itself composed of two independent enhancement layers, a first level 1 enhancement layer containing a depth map relating to the image of the base layer, a second level 1 enhancement layer containing the depth map relating to the image of the level 0 enhancement layer,
a level 2 enhancement layer containing occlusion data relating to the base layer image.

A single “stacked” format is used to diffuse the different 3D contents on different media and for different display systems, such as contents for 3D digital cinema, 3D DVD, 3D TV.

Thus 3D contents can be recovered coming from different existing production modes and the range of autostereoscopic display devices can be addressed, from a single transmission format.

Thanks to the definition of a format for the video itself, and due to the structuring of data in the stream, enabling the extraction and the selection of appropriate data, the compatibility of a 3D system with another is assured.

### BRIEF DESCRIPTION OF THE DRAWINGS

Other specific features and advantages will emerge clearly from the following description, the description provided as a non-restrictive example and referring to the annexed drawings wherein:

FIG. 1 shows, a production and diffusion system of 3D contents,

FIG. 2 shows, the organization of coding layers according to the invention.

### DETAILED DESCRIPTION OF THE EMBODIMENTS OF THE INVENTION

It seems that the multiview autostereoscopic screens, for example the Newsight screen provide the best results, in terms of quality return, when they are supplied with N views where the extremes correspond to a pair of stereoscopic views and where the intermediary images are interpolated, only when supplied with the result of a multicamera acquisition. This is due to the constraints that must be respected between the focals of the cameras, their aperture, their positioning (inter-camera distance, directions relative to optic axes, etc.), the size and the distance of the subject filmed. For real scenes, interior or exterior, and “realist” cameras, that is to say of reasonable focal length and apertures that do dot give an impression of distortion of the scene at the display, typically camera systems are used whose optical axes must be spaced at a distance of the order of 1 cm. The average human inter-ocular distance is 6.25 cm.

It would appear therefore advantageous to transform the data relating to multicameras into data relating to the right and left stereoscopic views corresponding with the inter-ocular distance. This data is processed to provide stereoscopic views with depth maps and possibly occlusion masks. It therefore becomes useless to transmit multiviews, that is to say data relating to the number of 2D images corresponding to the number of cameras used.

For data relating to stereoscopic cameras, the left and right images can be processed to provide, in addition to the images, depth maps and possibly occlusion masks enabling exploitation via autostereoscopic display devices after processing.

As for the depth information, this latter can be estimated from adapted means such as laser or infra-red or calculated by measurement of motion disparity between the right image and the left image of in a more manual way by estimation of the depth for the regions.

The video data from a single 2D camera can be processed to provide two images, two views permitting the relief. A 3D model can be created from this single 2D video, with human intervention consisting in for example a reconstruction of scenes via exploitation of successive views, to provide stereoscopic images.

It appears that the N views exploited for a multiview display system and coming from N cameras can in fact be calculated from the stereoscopic contents, by carrying out interpolations. Hence the stereoscopic contents can serve as a basis for the transmission of television signals, the data relating to the stereoscopic pair enabling the N views for the 3D display device to be obtained by interpolation and eventually by extrapolation.

By taking account of these observations, it can be deduced that the different data types necessary for the display of a 3D video content, according to the display device type are the following:
a single view and the depth map with possibly occlusion masks for the Philips 9 view type autostereoscopic display device,
a stereographic pair for:
   a sequential or metameric, polarized, 3D Digital Cinema projection,
   a stereoscopic display device with only two views, with the use of shutter or polarized glasses,
   an autostereoscopic display device with only two views with servo device at the position of the head or visual direction techniques known as head tracking and eye tracking,
a stereographic pair with possibly two depth maps to facilitate the interpolation of intermediary views if the two views transmitted are degraded by the compression, for a Newsight 8 views type autostereoscopic display device,
a stereographic pair with depth maps and different occlusion layers for display devices in compliance with the next FTV (Free viewpoint TV) standard, that is to say MVD and LDV compatible.

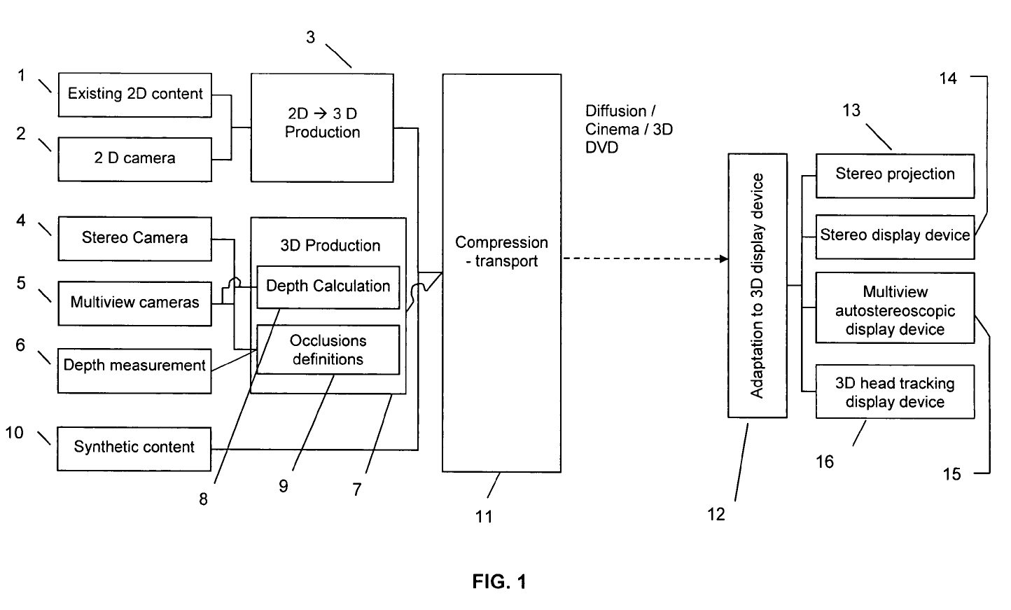

FIG. 1 shows schematically, the 3D contents production and diffusion system.

The current 2D conventional contents, coming from for example transmission or storage means, referenced 1, the video data from a standard 2D camera, referenced 2, are transmitted to the means of production, referenced 3, realizing the transformation into 3D video.

The video data from stereo cameras 4, from multiview cameras 5, the data from distance measurement means 6 are transmitted to a 3D production circuit 7. This circuit comprises a depth map calculation circuit 8 and an occlusion masks calculation circuit 9.

The video data coming from a synthetic images generation circuit 10 are transmitted to a compression and transport circuit 11. The information from 3D production circuits 3 and 7 are also transmitted to this circuit 11.

The compression and transport circuit 11 realizes the compression of data using, for example, the MPEG 4 compression method. The signals are adapted for transport, the transport stream syntax differentiating the object layers of the structuring of video data potentially available at input to the compression circuit and described later. This data from circuit 11 can be transmitted to the reception circuits in different ways:
by intermediary of a physical medium, arranged in a 3D DVD or other digital support,
by intermediary of a physical medium, stored in reels for the cinema (roll out),
by radio transmission, by cable, by satellite, etc.

The signals are thus transmitted by the compression and transport circuit according to the structure of the transport stream described later, the signals are arranged in the DVD, or reels, according to this transport stream structure. The signals are received by an adaptation circuit to the 3D display devices referenced 12. This block carries out, from different layers in the transport stream or the programme stream, the calculation of data required by the display device to which it is connected. The display devices are of type screen for stereographic projection 13, stereographic 14, autostereographic or multiview autostereoscopic 15, autostereoscopic with servo 16 or other.

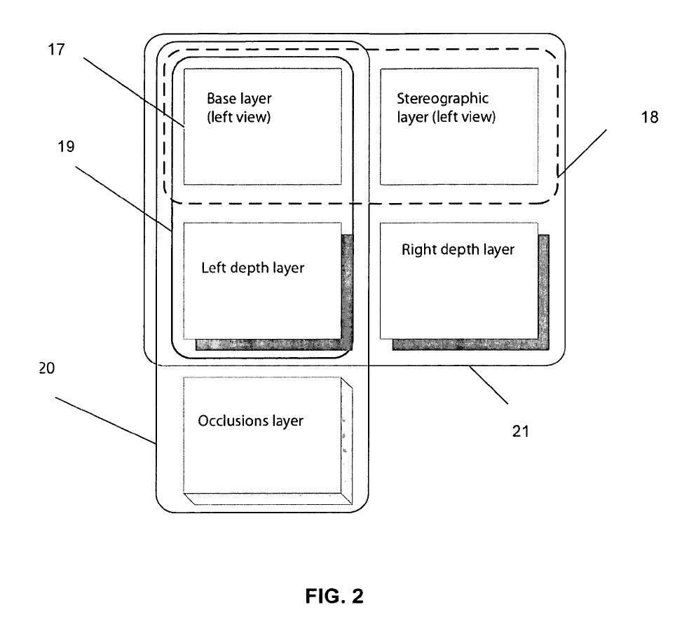

FIG. 2 schematically shows the stacking of different layers for the transport of data.

In the vertical direction are defined the layers of level zero, of level one and of level two. In the horizontal direction are defined, for a level, a first layer and possibly a second layer.

The video data of the first image of a stereoscopic pair, for example the left view of a stereoscopic image, are assigned a base layer, first layer of level zero according to the appellation proposed above. This base layer is that used by a standard television, the conventional type video data, for example the 2D data relating to the image displayed by a standard television, being also assigned to this base layer. A compatibility with existing products is thus maintained, a compatibility that does not exist in the standardization of Multiview Video Coding (MVC)

The video data of the second layer of the stereoscopic pair, for example the right view, are assigned to the second layer of level zero, called the stereographic layer. It involves an enhancement layer of the first layer of level zero.

The video data concerning the depth maps are assigned to enhancement layers of level one, the first layer of level one called the left depth layer for the left view, the second layer of level one is called right depth layer for the right view.

The video data relating to occlusion masks is assigned to an enhancement layer of level two, the first layer of level two is called the occlusions layer.

A stacked format for the video elementary stream, consists therefore in:
a base layer comprising a standard video, the left view of a pair of stereographics,
an enhancement layer of stereography comprising the right view of the pair of stereographics,
two depth enhancement layer, the depth maps corresponding to the left and right views of the stereographic pair,
an occlusion enhancement layer, N occlusion masks.

Due to this organization of data in the different layers, the contents can be converged that are relative to the stereoscopic devices for 3D digital cinema, to multiview type autostereoscopic devices or using depth maps and occlusion maps. The stacked format enables at least 5 different types of display device to be addressed. The configurations used for each of these types of display device are indicated in FIG. 2, the layers used for each of the configurations are grouped together.

The base layer, alone, reference 17, addresses conventional display devices.

The base layer adjoined to the stereographic layer, grouping referenced as 18, enables a 3D cinema type projection as well as the displaying of DVD on stereoscopic screens, with glasses, or autostereoscopic with only two views with head tracking.

The base layer associated with the “left” depth layer, grouping 19, enables a Philips 2D+z type display device to be addressed.

The base layer associated with the “left” depth layer and with the occlusion layer, that is to say the first layer at level zero and the first level one and two enhancement layers, grouping 20, enables an LDV (Layered Depth Video) type display device to be addressed.

The base layer associated with the stereographic layer and with the left and right depth layers, that is to say level zero and level one layers, grouping 21, addresses MVD (Multiview Video+Depth maps) type autostereoscopic 3DTV type display devices.

Such a structuring of the transport stream enables a convergence of formats, for example of type Philips 2D+z, 2D+z+occlusions, LDV with formats of type stereoscopic of type cinema and with formats of type LDV or MVD.

Returning to FIG. 1, the adaptation circuit to the 3D display 12 performs the selection of layers: selection of the base layer and the stereographic enhancement layer, that is to say the level zero layers, if the display consists in a stereoscopic projection 13 or exploits a 3D servo display device 16, selection of the base layer, of the left depth enhancement layer and the occlusion layer, that is to say the first level zero, one and two layers, for a display device of LDV type 14, selection of level zero and on layers for a display device of MDV multiview type 15. For example in this latter case, the adaptation circuit performs a calculation of 8 views from 2 stereoscopic views and depth maps to supply the MDV multiview type display device 15.

Hence, the conventional 2D or 3D video signals, whether they come from recording media, radio transmission or by cable, can be displayed on any 2D or 3D system. The decoder, that for example contains the adaptation circuit, selects and exploits the layers according to the 3D display system to which it is connected.

It is also possible to transmit to the receiver, for example by cable, due to this structuring, only the layers required by the 3D display system used.

The invention is described in the preceding text as an example. It is understood that those skilled in the art are capable of producing variants of the invention without leaving the scope of the invention.

1. Coding device intended to exploit the data from different 3D production means, data relating to a right image and a left image, data relating to depth maps associated with right images and/or left images and/or data relating to occlusion layers, comprising means to generate a stream structured on several levels:
a level 0 comprising two layers, a base layer containing the video data of the right image and a level 0 enhancement layer containing the video data of the left image, or conversely,
a level 1 comprising two enhancement layers, a first level 1 enhancement layer containing a depth map relating to the image of the base layer, a second level 1 enhancement layer containing a depth map relating to the level 0 enhancement layer image,
a level 2 comprising a level 2 enhancement layer containing occlusion data relating to the base layer image.

2. Device according to claim 1, wherein the data relating to level 0, level 1 or level 2 comes from 3D synthesis image generation means and/or the 3D data means of production from:
2D data from 2D cameras and/or 2D video content and/or
data from stereo cameras and/or multiview cameras

3. Device according to claim 1, wherein the 3D data production means use, for the calculation of data relating to level 1, specific means for depth information acquisition and/or means for depth map calculation from data coming from stereo cameras and/or multiview cameras

4. Device according to claim 1, wherein the 3D data production means use, for the calculation of data relating to level 2, occlusion map calculation means from data coming from depth information acquisition means, from stereo cameras and/or multiview cameras.

5. Decoding device of 3D data from a stream for its display on a screen, structured on several levels:
a level zero comprising two layers, a base layer containing the video data of the right image and a level zero enhancement layer containing the video data of the left image, or conversely,
a level 1 comprising two enhancement layers, a first level 1 enhancement layer containing a depth map relating to the image of the base layer, a second level 1 enhancement layer containing a depth map relating to the level 0 enhancement layer image,
a level 2 comprising a level 2 enhancement layer containing occlusion data relating to the base layer image,
for their display on a display device, comprising a 3D display adaptation circuit using the data of one or more data stream layers received to render them compatible with the display device.

6. Device according to claim 5, wherein the 3D display adaptation circuit uses:
level 0 layers when the display is on a 3D cinema screen, on a 2 view stereoscopic screen requiring the use of glasses, or on a 2 view autostereoscopic screen,
the base layer and the first level 1 enhancement layer when the display is on a Philips “2D+z” type screen,
all of the level 0 and level 1 layers when the display is on an MVD type autostereoscopic 3DTV,
the base layer, the first enhancement layer of level 1 and of level 2 when the display is on a LDV type screen.

7. Video data transport stream, wherein the stream syntax differentiates the data layers according to the following structure:
a layer of level 0 composed of two layers, one base layer containing the video data of the right image and an enhancement layer containing video data of the left image, or conversely,
an enhancement layer of level 1 itself composed of two enhancement layers, a first level 1 enhancement layer containing a depth map relating to the image of the base layer, a second level 1 enhancement layer containing the depth map relating to the image of the level 0 enhancement layer,
a level 2 enhancement layer containing occlusion data relating to the base layer image.
